(19) United States
(12) Patent Application Publication
(10) Pub. No.: US 2023/0302949 A1
(43) Pub. Date: Sep. 28, 2023

(54) ELECTRIC VEHICLE CHARGING STATION MANAGEMENT METHODS AND SYSTEMS FOR ROAMING CHARGING

(71) Applicant: Noodoe Corporation, Taipei City (TW)

(72) Inventors: YU-TING LIOU, Taipei City (TW); CHIA-WEI HU, Taipei City (TW); YAN-MING CHEN, Taipei City (TW); YI-AN HOU, Taipei City (TW)

(21) Appl. No.: 18/060,989

(22) Filed: Dec. 2, 2022

(30) Foreign Application Priority Data
Mar. 22, 2022 (TW) 111110660

(51) Int. Cl. B60L 53/68; H02J 7/00; G06Q 30/04; G06K 7/14

(52) U.S. Cl. CPC B60L 53/68; H02J 7/00032; G06Q 30/04; G06K 7/1417

(57) ABSTRACT

Electric vehicle charging station management methods and systems for roaming charging are provided. First, a mobile device executes an application program to obtain identification data of an electric vehicle charging station, and transmits charging request data including the identification data to a first server corresponding to the application program through a first network. The first server determines a charging station operator of the electric vehicle charging station according to the charging request data, and transmits the charging request data to a second server of the charging station operator through a second network. The second server transmits a charging start instruction to the electric vehicle charging station through a third network in response to the charging request data, so that the electric vehicle charging station starts to perform a charging operation.

### BACKGROUND OF THE INVENTION

### Field of the Invention

The disclosure relates generally to management methods and systems for electric vehicle charging stations, and, more particularly to electric vehicle charging station management methods and systems in the case of roaming charging.

### Description of the Related Art

Recently, with the rising awareness of environmental protection and electric vehicle technology advances, the development of electric vehicles powered by electrical energy to replace traditional vehicles powered by fossil fuels has gradually become an important goal in the automotive field, thus making electric vehicles become more and more popular. In order to increase the range and willingness to use electric vehicles, many countries or cities have begun to set up charging stations in public places to provide electricity to electric vehicles, and have also begun to plan the deployment of a large number of charging stations in urban areas or scenic areas, so as to make the charging of electric vehicles more convenient.

Currently, different electric vehicle charging stations can be set up and managed by different charging station operators. To provide a more user-friendly electric vehicle charging experience, many operators of electric vehicle charging stations have developed applications on mobile phones that allow users to search for electric vehicle charging stations, start charging, stop charging, and view charging progress and other functions. Individual charging station operators can invite users to become members and offer a variety of charging options to meet the needs of different users.

As electric vehicle users may carry out long-distance or cross-regional movement, such as traveling, and there may only be EV charging stations of a particular charging station operator in a particular area. As a result, it is often the case that members of one charging station operator goes to another charging station operator's electric vehicle charging station to charge their vehicles. In view of this, the industry refers to this behavior as “roaming charging”. Conventionally, a member of charging station operator A can use the application of a charging station operator A to activate the electric vehicle charging station of a charging station operator B. Users must identify the operator data and electric vehicle charging station information by themselves, and enter them into the application to request charging permission from the backend platform of the charging station operator A. The foregoing process is very complicated and cumbersome process for ordinary users, which in turn makes roaming charging difficult for the users.

### BRIEF SUMMARY OF THE INVENTION

In an electric vehicle charging station management method for roaming charging, a mobile device first executes an application program to obtain identification data of an electric vehicle charging station, and transmits charging request data at least including the identification data to a first server corresponding to the application program through a first network. The first server determines a charging station operator of the electric vehicle charging station according to the charging request data, and transmits the charging request data to a second server of the charging station operator through a second network. The second server transmits a charging start instruction to the electric vehicle charging station through a third network in response to the charging request data, so that the electric vehicle charging station starts to perform a charging operation.

An embodiment of an electric vehicle charging station management system for roaming charging comprises at least one electric vehicle charging station, a mobile device, a first server, and a second server. The electric vehicle charging station is electrically coupled with an electric vehicle. The mobile device executes an application program to obtain identification data of an electric vehicle charging station, and transmits charging request data at least including the identification data to a first server corresponding to the application program through a first network. The first server determines a charging station operator of the electric vehicle charging station according to the charging request data, and transmits the charging request data to a second server of the charging station operator through a second network. The second server transmits a charging start instruction to the electric vehicle charging station through a third network in response to the charging request data, so that the electric vehicle charging station starts to perform a charging operation.

In some embodiments, a scanning function of the application program is used to scan a two-dimensional barcode corresponding to the electric vehicle charging station, so as to obtain identification data of the electric vehicle charging station. The first server parses the identification data in the charging request data according to a coding logic to determine the charging station operator corresponding to the electric vehicle charging station.

In some embodiments, the first server obtains a charging station code of the electric vehicle charging station and operator data corresponding to the charging station operator from the identification data according to the coding logic.

In some embodiments, the mobile device further obtains operator data of the electric vehicle charging station, and integrates the operator data into the charging request data, and sends the charging request data to the first server corresponding to the application program.

In some embodiments, the first network is a wireless network provided by a charging station operator of the electric vehicle charging station, and the mobile device obtains the operator data of the charging station operator through the wireless network.

In some embodiments, the mobile device obtains a geographic location through a positioning unit, and determines the operator data based on the geographic location and a charging station database.

In some embodiments, the mobile device uses a wireless receiving unit to receive a broadcast signal through a wireless network, and determines the operator data according to the broadcast signal.

In some embodiments, the mobile device obtains a geographic location through a positioning unit, integrates the geographic location into the charging request data, and sends the charging request data to the first server corresponding to the application program. The first server determines the charging station operator of the electric vehicle charging station according to the geographic location and a charging station database.

In some embodiments, the second server receives charging data corresponding to the charging operation from the electric vehicle charging station through the third network. The second server calculates a charging fee according to the charging data, and sends the charging fee to the first server through the second network.

Electric vehicle charging station management methods for roaming charging may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an electric vehicle charging station management system for roaming charging of the invention;

FIG. 2 is a schematic diagram illustrating an embodiment of an electric vehicle charging station of the invention;

FIG. 3 is a schematic diagram illustrating an embodiment of a server of the invention;

FIG. 4 is a flowchart of an embodiment of an electric vehicle charging station management method for roaming charging of the invention;

FIG. 5 is a flowchart of an embodiment of a method for obtaining charging station operator data of the invention;

FIG. 6 is a flowchart of another embodiment of an electric vehicle charging station management method for roaming charging of the invention;

FIG. 7 is a flowchart of another embodiment of a method for obtaining charging station operator data of the invention;

FIG. 8 is a flowchart of another embodiment of a method for obtaining charging station operator data of the invention;

FIG. 9 is a flowchart of another embodiment of a method for obtaining charging station operator data of the invention; and

FIG. 10 is a flowchart of another embodiment of an electric vehicle charging station management method for roaming charging of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

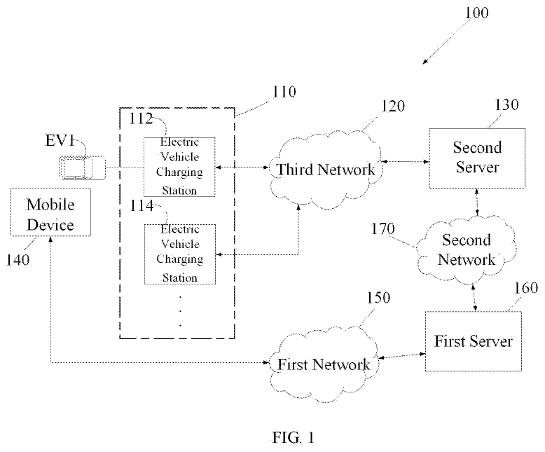

FIG. 1 is a schematic diagram illustrating an embodiment of an electric vehicle charging station management system for roaming charging of the invention. The electric vehicle charging station management system for roaming charging 100 comprises at least one electric vehicle charging station corresponding to a first charging station operator, such as electric vehicle charging stations (112, 114), and a second server 130 respectively connected with respective charging station via a third network 120. The electric vehicle charging stations may be located in a charging field 110. The respective charging stations can provide electric vehicles for charging operations. In some embodiments, the third network 120 may be a wired network, a telecommunication network, and a wireless network, such as a Wi-Fi network. The second server 130 can be a backend platform for the first charging station operator to manage the electric vehicle charging station. The second server 130 can respectively receive various data from the electric vehicle charging stations (112, 114), and transmit related signals to the electric vehicle charging stations (112, 114). The electric vehicle charging stations (112, 114) can perform related operations according to the signals received from the second server 130. For example, when the electric vehicle EV1 is coupled to the electric vehicle charging station 112 through a charging gun of the first charging station 112 for a charging operation, the electric vehicle charging station 112 can continuously transmit charging information corresponding the charging operation of the electric vehicle EV1 via the third network 120, and the second server 130 can receive the charging information of the corresponding charging operation from the electric vehicle charging station 112 via the third network 120. Similarly, when the electric vehicle EV2 is coupled to the electric vehicle charging station 114 through a charging gun of the electric vehicle charging station 114 to perform a charging operation, the electric vehicle charging station 114 can continuously transmit the charging information corresponding the charging operation of the electric vehicle EV2 via the third network 120, and the second server 130 can receive the charging information of the corresponding charging operation from the electric vehicle charging station 114 via the third network 120. In some embodiments, the charging information may include at least a charging start time, a charging period, an output power, and/or related information indicating whether a load adjustment operation is being performed. The second server 130 can know the usage status of the corresponding electric vehicle charging station according to the charging information.

It is noted that the user can connect the electric vehicle EV1 and the electric vehicle charging station 112 to each other, such as inserting a charging gun into the charging port of the electric vehicle to send a charging request corresponding to the electric vehicle charging station 112 to use the electric vehicle charging station 112 to perform a charging operation for the electric vehicle EV1. Similarly, the user can connect the electric vehicle EV2 and the electric vehicle charging station 114 to each other, such as inserting a charging gun into the charging port of the electric vehicle to send a charging request corresponding to the electric vehicle charging station 114 to use the electric vehicle charging station 114 to perform a charging operation for the electric vehicle EV2. It is understood that, in some embodiments, the second server 130 may directly or indirectly receive a charging request from a mobile device 140 of the owner of the electric vehicle EV1, and generate a charging authorization command based on the charging request and transmit it to the electric vehicle charging station 112 via the third network 120, so that the electric vehicle charging station 112 outputs power to the electric vehicle EV1, such as an electric scooter or an electric car, which is electrically connected to it, or prohibits the first charging station 112 from outputting power to the electric vehicle EV1. It is reminded that, in some embodiments, the charging request may be accompanied by an identity authentication and/or a payment mechanism, and the charging authorization command will only be generated after the identity authentication and/or payment mechanism is completed. In some embodiments, the user of the electric vehicle EV1 can use his/her mobile device to download and install an application to generate a charging request through the user interface of the application. In some embodiments, the user can scan a Quick Response Code (QR code) on the electric vehicle charging station 112 through the scanning function of the application to generate the above-mentioned charging request, thereby starting a charging operation. In some embodiments, the user can select a specific charging station through the application and execute an activation function to generate the above-mentioned charging request, thereby starting a charging operation. It is understood that, in some embodiments, the owner of the electric vehicle EV1 can use an RFID card to approach an induction area (not shown in FIG. 1) on the electric vehicle charging station 112 to generate a corresponding charging request, and sent it to the second server 130 via the third network 120. It is reminded that, in some embodiments, each user can have an RFID card. It is noted that, in some embodiments, the owner of the electric vehicle EV1 may be a member of a second charging station operator and may wish to roam to the first charging station operator's electric vehicle charging station 112 for charging. The operation of which will be described later. The electric vehicle charging station management system for roaming charging 100 of the invention may also include a first server 160 used by the corresponding second charging station operator to manage its members or electric vehicle charging stations. The mobile device 140 of the electric vehicle owner can be coupled with the first server 160 through a first network 150, and the first server 160 of the second charging station operator can communicate with the second server 130 of the first charging station operator via a second network 170 with a roaming protocol.

It is noted that, the mobile device 140 may be corresponded to the owner of the electric vehicle, which can be any electronic device capable of Internet access, such as mobile devices, such as mobile phones, smart phones, personal digital assistants, global positioning systems, and notebook computers. In some embodiments, the mobile device 140 can receive status information and notifications of the corresponding charging operation from the cloud management server via the network. In some embodiments, the status information and notification may include notifying that the electric vehicle has stopped charging, notifying that the vehicle needed to be moved, and/or notifying that the charging gun of the electric vehicle charging device has been disconnected from the electric vehicle, and so on. It is noted that, in some embodiments, when the owner of the electric vehicle EV1 is a member of the second charging station operator, the mobile device 140 can receive status information and notifications of the corresponding charging operation from the first server 160 corresponding to the second charging station operator via the first network 150.

It is understood that, in some embodiments, the second server 130 can perform a load adjustment operation for the electric vehicle charging stations according to at least one energy management scheme. Specifically, the second server 130 can generate an instruction and send the instruction to the respective electric vehicle charging stations (112, 114) via the third network 120 to control the electric vehicle charging station to output power for charging with a specified power parameter, such as a specified amperage, during a specific period of time to the electric vehicle connected to the station, or to prohibit the electric vehicle charging station from outputting power to the electric vehicle.

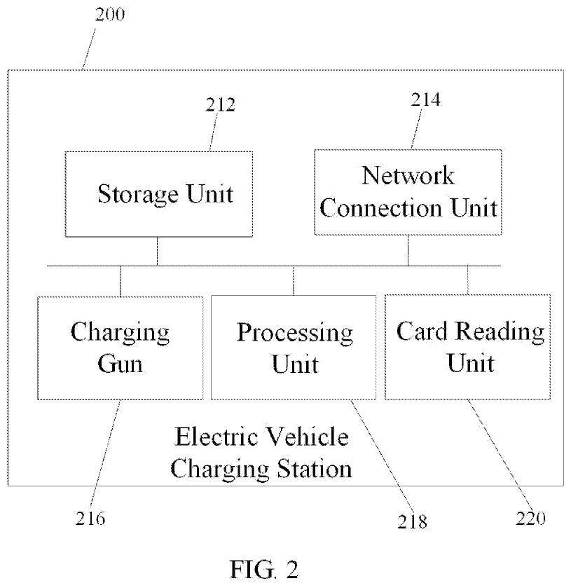

FIG. 2 is a schematic diagram illustrating an embodiment of an electric vehicle charging station of the invention. The electric vehicle charging station 200 shown in FIG. 2 can be applied to the electric vehicle charging stations (112, 114) in FIG. 1, which has processing and computing capabilities to perform charging management operations for the electric vehicle charging station. The electric vehicle charging station 200 has a network connection capability to receive, download or update various parameters and information required for charging management calculations.

The electric vehicle charging station 200 at least comprises a storage unit 212, a network connection unit 214, a charging gun 216, a processing unit 218, and a card reading unit 220. The storage unit 212 may be a memory or a database for storing and recording related data. The data may be related information such as charging station ID of the electric vehicle charging station and charging requests. It should be noted that the aforementioned information is only example, and the invention is not limited thereto. The network connection unit 214 can use a network, such as a wired network, a telecommunications network, and a wireless network, such as a Wi-Fi network, to receive, download, or update various parameters and information required for charging management operations. The charging gun 216 may include one or more charging connectors that meet the same charging interface specification or meet different charging interface specifications, and are electrically connected to the corresponding electric vehicle. The processing unit 218 can control the operations of related software and hardware in the electric vehicle charging station 200, and cooperate with the second server 130 to execute the electric vehicle charging station management method for roaming charging of the invention. Related details will be described later. It is noted that, in some embodiments, the processing unit 218 may be a general-purpose controller, a Micro-Control Unit, MCU, or a Digital Signal Processor, DSP, etc., to provide functions of data analysis, processing and calculation, but the present invention is not limited to this. In one embodiment, the processing unit 218 may use the network connection unit 214 to transmit the power state of the corresponding electric vehicle through a network for a cloud management server, such as the second server 130, for subsequent charging management. In another embodiment, the processing unit 218 can obtain the power parameter of a charging operation from the second server 130, determine the output power according to the power parameter received from the second server 130, and output the power to at least one electric vehicle through the charging gun 216 to perform the charging operation. The card reading unit 220 may be an RFID reading unit for sensing information of a physical card, such as RFID card. The information sensed from the RFID card may be a card identification code of the physical card.

It is understood that, the electric vehicle charging station 200 has an upper power limit value and a lower power limit value. Specifically, the electric vehicle charging station 200 can use the upper power limit value as the power parameter at the highest to output power to the electric vehicle during a charging operation. On the other hand, the electric vehicle charging station 200 needs to use the lower power limit value as the power parameter at least to output power to the electric vehicle during a charging operation. It must be noted that, charging stations of different brands and models may have different upper power limit values for output power and lower power limit values for output power. The present invention is not limited to any value, and the value may be different for different charging stations.

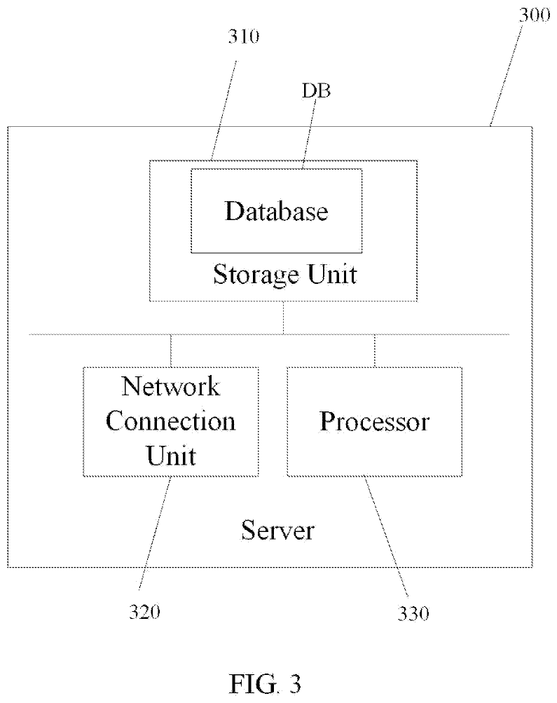

FIG. 3 is a schematic diagram illustrating an embodiment of a server of the invention. It is noted that the server 300 in FIG. 3 can be applied to the second server 130 or the first server 160, both of which have similar structures. As shown in FIG. 3, the server 300 of the invention can be any processor-based electronic device, which comprises at least a storage unit 310, a network connection unit 320, and a processor 330. It is noted that, the server 300 can receive various data corresponding to a plurality of electric vehicle charging stations in a charging field. The server 300 can directly or indirectly receive a charging request from a mobile device, and after completing actions such as identity confirmation in response to the charging request, generate a charging authorization command and transmit it to the corresponding electric vehicle charging station via the network. In response to the charging authorization command, the electric vehicle charging station is allowed to output power to an electric vehicle (for example, an electric motorcycle or an electric vehicle, etc.) that is electrically connected to it, or prohibit the electric vehicle charging station from outputting power to the electric vehicle.

The storage unit 310 may be a memory comprising a database DB, which can store and record related data, such as various data of the electric vehicle charging stations. In addition, in some embodiments, the database DB may also record different users and corresponding user identification codes. In some embodiments, the database DB may record a coding logic. In some embodiments, the database DB may record an coding logic. The coding logic can be used to parse the identification data in the charging request data to determine the identification data of the EV charging station, and/or the corresponding charging station operator/operator data. Through the network connection unit 320, the server 300 can be coupled to and communicates with the electric vehicle charging stations via the network, such as a wired network, a telecommunications network, and a wireless network, such as a Wi-Fi network, and transmits related data/signals/commands to different electric vehicle charging stations via the network to control whether the electric vehicle charging stations output power, and specify power parameters for outputting power to electric vehicles. On the other hand, through the network connection unit 320, the server 300 can also be coupled and communicates with the mobile device via the network, and transmit related data/signals/commands to the mobile device via the network. The processor 330 can control the operations of related software and hardware in the server 300, and execute the electric vehicle charging station management methods for roaming charging of the invention. The relevant details will be described later. It is understood that, in some embodiments, the processor 330 may be a general-purpose controller, a Micro-Control Unit, MCU, or a Digital Signal Processor, DSP, etc., to provide data analysis, processing, and calculation functions.

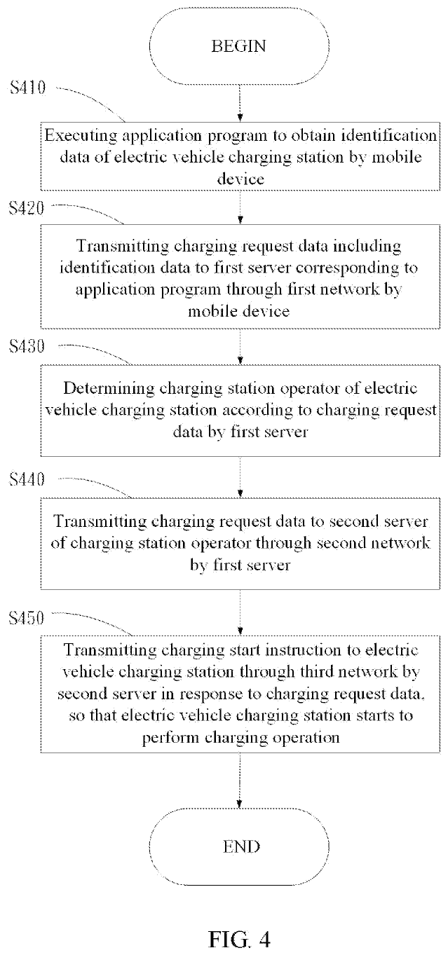

FIG. 4 is a flowchart of an embodiment of an electric vehicle charging station management method for roaming charging of the invention

First, in step S410, a mobile device is used to execute an application program to obtain identification data corresponding to an electric vehicle charging station. It is noted that, in this embodiment, the electric vehicle charging station belongs to the first operator and is managed by a second server. The mobile device is a member corresponding to a second charging station operator, and can communicate with a first server through the network. Next, in step S420, the mobile device transmits charging request data including at least one identification data to the first server corresponding to the application program through a first network. In step S430, the first server determines a charging station operator (the first charging station operator) of the electric vehicle charging station according to the charging request data, and in step S440, sends the charging request data to the second server corresponding to the charging station operator (the first charging station operator). In step S450, the second server sends a charging start instruction to the electric vehicle charging station through a third network in response to the charging request data, so that the electric vehicle charging station starts to perform a charging operation. It is noted that, in some embodiments, when the charging operation is in progress, the electric vehicle charging station can continuously transmit the charging data corresponding to the charging operation, such as charging progress, charging fee, etc., to the second server, and the second server can transmit the charging data to the mobile device through the first server.

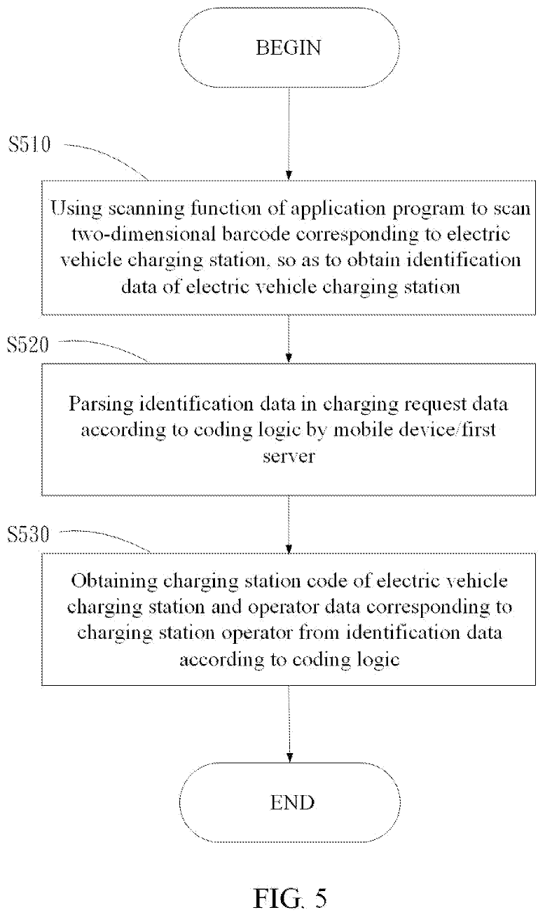

FIG. 5 is a flowchart of an embodiment of a method for obtaining charging station operator data of the invention. First, in step S510, the mobile device uses a scanning function of the application program to scan a two-dimensional barcode, such as a QR code, corresponding to the electric vehicle charging station to obtain identification data of the electric vehicle charging station. In step S520, the mobile device/first server parses the identification data in the charging request data according to a coding logic, and in step S530, obtains a charging station code corresponding to the electric vehicle charging station and operator data corresponding to the charging station operator according to the coding logic so as to determine the charging station operator corresponding to the electric vehicle charging station.

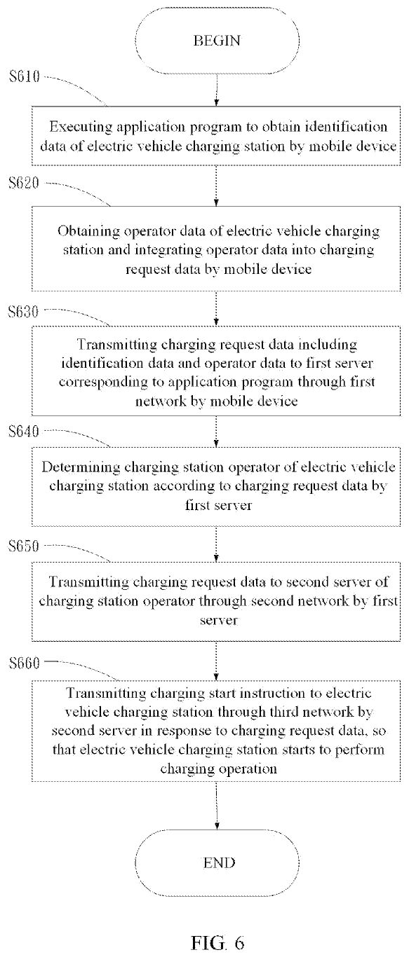

FIG. 6 is a flowchart of another embodiment of an electric vehicle charging station management method for roaming charging of the invention.

First, in step S610, a mobile device is used to execute an application program to obtain identification data corresponding to an electric vehicle charging station. Similarly, in this embodiment, the electric vehicle charging station belongs to a first operator and is managed by a second server. The mobile device is a member corresponding to a second charging station operator, and can communicate with a first server through the network. The mobile device can integrate the identification data into charging request data. In step S620, the mobile device obtains the operator data of the electric vehicle charging station, and integrates the operator data into the charging request data. Next, in step S630, the mobile device transmits the charging request data including at least the identification data and the operator data to the first server corresponding to the application program through a first network. In step S640, the first server determines a charging station operator (the first charging station operator) corresponding to the electric vehicle charging station according to the charging request data, and in step S650, sends the charging request data to the second server corresponding to the charging station operator (the first charging station operator). In step S660, the second server sends a charging start instruction to the electric vehicle charging station through a third network in response to the charging request data, so that the electric vehicle charging station starts to perform a charging operation. It is reminded that, similarly, when the charging operation is in progress, the electric vehicle charging station can continuously transmit the charging data corresponding to the charging operation, such as charging progress, charging fee, etc., to the second server, and the second server can transmit the charging data to the mobile device through the first server.

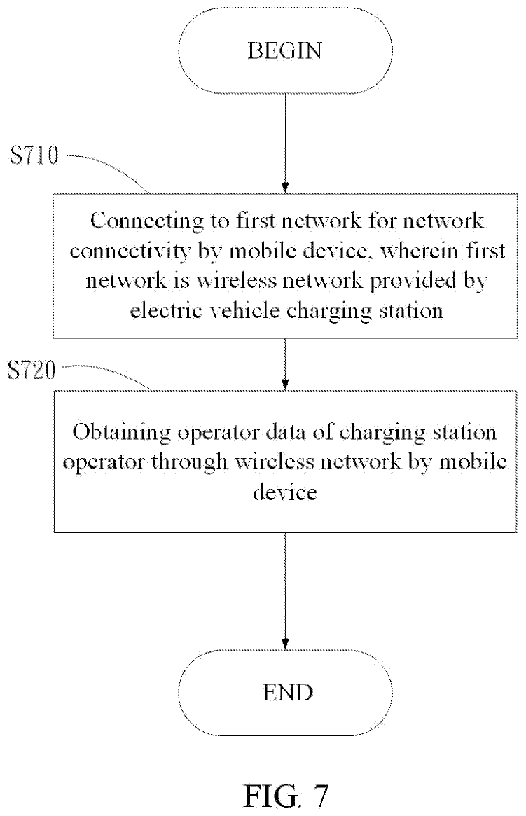

FIG. 7 is a flowchart of another embodiment of a method for obtaining charging station operator data of the invention. In step S710, the mobile device connects to a first network in the charging field. It is noted that the first network is a wireless network provided by a charging station operator corresponding to the electric vehicle charging station. In step S720, the mobile device obtains the operator data of the charging station operator through the wireless network.

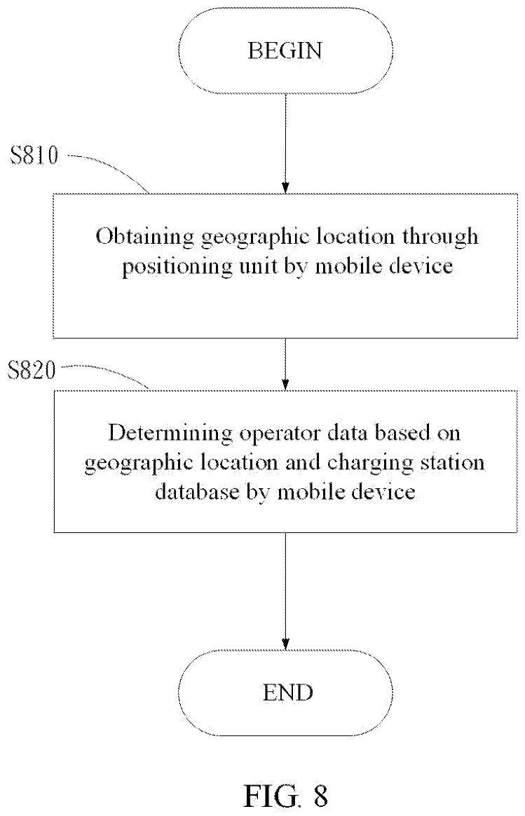

FIG. 8 is a flowchart of another embodiment of a method for obtaining charging station operator data of the invention. In step S810, the mobile device obtains a geographic location through a positioning unit, and in step S820, determines the operator data according to the geographic location and a charging station database.

It should be noted that, in some embodiments, the geographic location can be sent to the first server for performing the operator determination. For example, after the mobile device obtains the geographic location through the positioning unit, the mobile device can integrate the geographic location into the charging request data, and send the charging request data to the first server corresponding to the application program. The first server can determine the charging station operator of the electric vehicle charging station according to the geographic location and a charging station database.

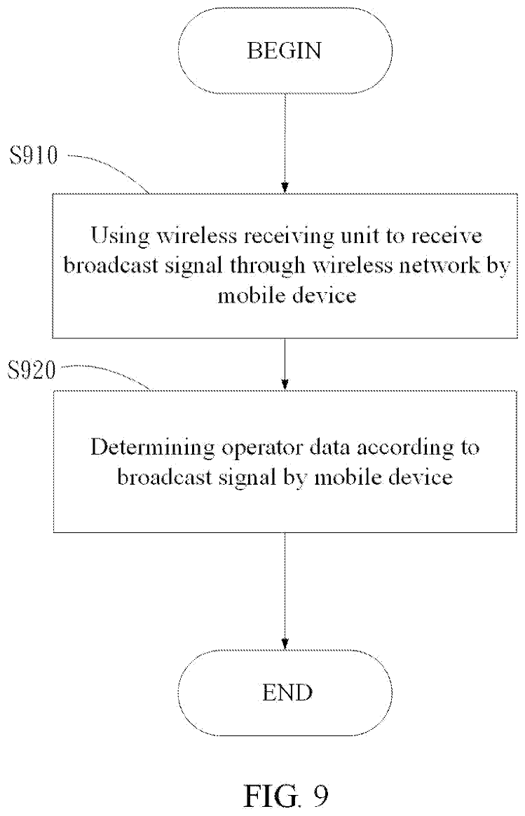

FIG. 9 is a flowchart of another embodiment of a method for obtaining charging station operator data of the invention. In step S910, the mobile device uses a wireless receiving unit to receive a broadcast signal through a wireless network. In step S920, operator data is determined according to the received broadcast signal.

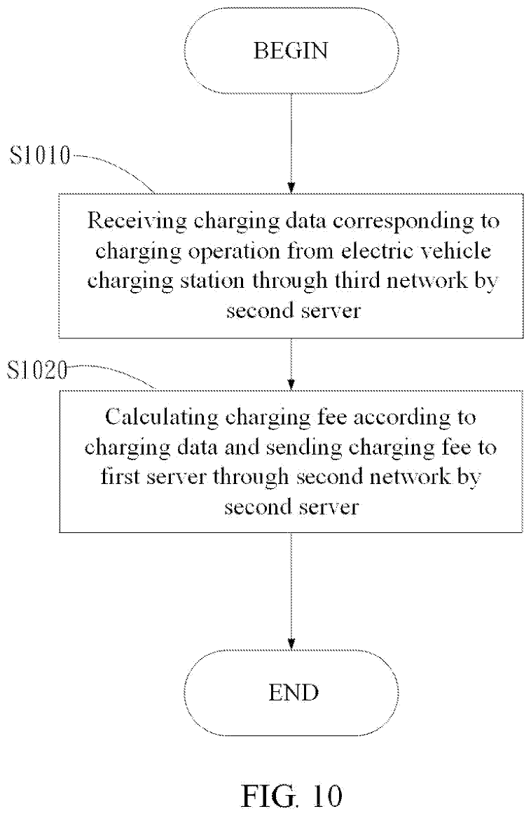

FIG. 10 is a flowchart of another embodiment of an electric vehicle charging station management method for roaming charging of the invention. As mentioned above, when the charging operation is in progress, the electric vehicle charging station can continuously transmit the charging data corresponding to the charging operation, such as charging progress, charging fee, etc., to the second server. First, in step S1010, the second server receives charging data corresponding to the charging operation from the electric vehicle charging station through the third network. In step S1020, the second server calculates a charging fee according to the charging data, and sends the charging fee to the first server through the second network. After the first server receives the charging fee corresponding to the charging operation, it can notify the mobile device or carry out a subsequent charge split between the charging station operators. It is noted that, when the charging operation is interrupted/finished, the electric vehicle charging station will communicate with the second server, and the second server will settle the relevant charging fee and notify the first server.

Therefore, the electric vehicle charging station management methods and systems for roaming charging of the present invention can provide management of electric vehicle charging station activation across charging station operators during roaming charging, thus reducing the cumbersome operation of the user in the traditional roaming charging situation, and improving the smoothness and satisfaction of the overall charging experience.

Electric vehicle charging station management methods for roaming charging, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. An electric vehicle charging station management method for roaming charging, comprising:
executing an application program to obtain identification data of an electric vehicle charging station by a mobile device;
transmitting charging request data including the identification data to a first server corresponding to the application program through a first network by the mobile device;
determining a charging station operator of the electric vehicle charging station according to the charging request data by the first server;
transmitting the charging request data to a second server of the charging station operator through a second network by the first server; and
transmitting a charging start instruction to the electric vehicle charging station through a third network by the second server in response to the charging request data, so that the electric vehicle charging station starts to perform a charging operation.

2. The method of claim 1, further comprising:
using a scanning function of the application program to scan a two-dimensional barcode corresponding to the electric vehicle charging station, so as to obtain identification data of the electric vehicle charging station; and
parsing the identification data in the charging request data according to a coding logic to determine the charging station operator corresponding to the electric vehicle charging station by the first server.

3. The method of claim 2, further comprising a step of obtaining a charging station code of the electric vehicle charging station and operator data corresponding to the charging station operator from the identification data according to the coding logic by the first server.

4. The method of claim 1, further comprising:
obtaining operator data of the electric vehicle charging station by the mobile device; and
integrating the operator data into the charging request data, and sending the charging request data to the first server corresponding to the application program.

5. The method of claim 4, wherein the first network is a wireless network provided by a charging station operator of the electric vehicle charging station, and the method further comprises a step of obtaining the operator data of the charging station operator through the wireless network by the mobile device.

6. The method of claim 4, further comprising:
obtaining a geographic location through a positioning unit by the mobile device; and
determining the operator data based on the geographic location and a charging station database by the mobile device.

7. The method of claim 4, further comprising:
using a wireless receiving unit to receive a broadcast signal through a wireless network by the mobile device; and
determining the operator data according to the broadcast signal by the mobile device.

8. The method of claim 1, further comprising:
obtaining a geographic location through a positioning unit by the mobile device;
integrating the geographic location into the charging request data and sending the charging request data to the first server corresponding to the application program by the mobile device; and
determining the charging station operator of the electric vehicle charging station according to the geographic location and a charging station database by the first server.

9. The method of claim 1, further comprising:
receiving charging data corresponding to the charging operation from the electric vehicle charging station through the third network by the second server; and
calculating a charging fee according to the charging data and sending the charging fee to the first server through the second network by the second server.

10. An electric vehicle charging station management system for roaming charging, comprising:
at least one electric vehicle charging station electrically coupled to an electric vehicle;
a mobile device executing an application program to obtain identification data of an electric vehicle charging station, and transmitting charging request data at least including the identification data through a first network;
a first server corresponding to the application program, receiving the charging request data from the mobile device, determining a charging station operator of the electric vehicle charging station according to the charging request data, and transmitting the charging request data through a second network; and
a second server corresponding to the charging station operator, receiving the charging request data from the first server, transmitting a charging start instruction to the electric vehicle charging station through a third network in response to the charging request data, so that the electric vehicle charging station starts to perform a charging operation.

11. The system of claim 10, wherein the mobile device further uses a scanning function of the application program to scan a two-dimensional barcode corresponding to the electric vehicle charging station, so as to obtain identification data of the electric vehicle charging station, and the first server further parses the identification data in the charging request data according to a coding logic to determine the charging station operator corresponding to the electric vehicle charging station by the first server.

12. The system of claim 11, wherein the first server further obtains a charging station code of the electric vehicle charging station and operator data corresponding to the charging station operator from the identification data according to the coding logic.

13. The system of claim 10, wherein the mobile device further obtains operator data of the electric vehicle charging station, integrates the operator data into the charging request data, and sends the charging request data to the first server corresponding to the application program.

14. The system of claim 13, wherein the first network is a wireless network provided by a charging station operator of the electric vehicle charging station, and the mobile device further obtains the operator data of the charging station operator through the wireless network.

15. The system of claim 13, wherein the mobile device further obtains a geographic location through a positioning unit, and determines the operator data based on the geographic location and a charging station database.

16. The system of claim 13, wherein the mobile device further uses a wireless receiving unit to receive a broadcast signal through a wireless network and determines the operator data according to the broadcast signal.

17. The system of claim 10, wherein the mobile device further obtains a geographic location through a positioning unit, integrates the geographic location into the charging request data and sends the charging request data to the first server corresponding to the application program, and the first server further determines the charging station operator of the electric vehicle charging station according to the geographic location and a charging station database.

18. The system of claim 10, wherein the second server further receives charging data corresponding to the charging operation from the electric vehicle charging station through the third network, calculates a charging fee according to the charging data, and sends the charging fee to the first server through the second network.

19. A machine-readable storage medium comprising a computer program, which, when executed, causes a device to perform an electric vehicle charging station management method for roaming charging, wherein the method comprises:
executing an application program to obtain identification data of an electric vehicle charging station by a mobile device;
transmitting charging request data including the identification data to a first server corresponding to the application program through a first network by the mobile device;
determining a charging station operator of the electric vehicle charging station according to the charging request data by the first server;
transmitting the charging request data to a second server of the charging station operator through a second network by the first server; and
transmitting a charging start instruction to the electric vehicle charging station through a third network by the second server in response to the charging request data, so that the electric vehicle charging station starts to perform a charging operation.
